(19) United States
(12) Patent Application Publication
(10) Pub. No.: US 2024/0345553 A1
(43) Pub. Date: Oct. 17, 2024

(54) MULTI-FACTOR VERIFICATION SYSTEM, MULTI-FACTOR VERIFICATION METHOD, AND PROGRAM

(71) Applicant: NIPPON TELEGRAPH AND TELEPHONE CORPORATION, Tokyo (JP)

(72) Inventors: Kotaro ONO, Tokyo (JP); Kenta KAWAKAMI, Tokyo (JP); Takeshi KUWAHARA, Tokyo (JP)

(21) Appl. No.: 18/294,334

(22) PCT Filed: Sep. 27, 2021
(86) PCT No.: PCT/JP2021/035406

§ 371 Date: Feb. 1, 2024

(51) Int. Cl. G05B 15/02

(52) U.S. Cl. CPC G05B 15/02

(57) ABSTRACT

A multi-factor collating system is in a cyber-physical system in which a physical space and a cyber space are connected by a network. The multi-factor collating system includes a computer including a memory and a processor configured to determine whether to project an object onto the cyber space, based on first positional information that is positional information of the object obtained by positioning means of the object in the physical space, and second positional information that is positional information of the object obtained by means other than the positioning means; and project the object to the cyber space, in response to a determination that the object is to be projected to the cyber space.

### TECHNICAL FIELD

The present invention relates to a technique for projecting a physical space onto a logical space in a Cyber-Physical System in which a physical space and a logical space are connected by a network.

### BACKGROUND ART

A technique called a Cyber-Physical System (hereinafter, CPS) has been studied. The CPS is a technique for capturing an object and a phenomenon on a physical (physical space) space by utilizing a technique related to object detection using a sensor such as a camera and a light detection and ranging (LIDAR), a positioning technique based on a global navigation satellite system (GNSS) signal, or the like, and projecting the captured situation on the logical (cyber) space connected by the network (NW), thereby executing a control, a simulation, and the like of the physical space or performing an enhancement.

In order to appropriately change (control) the physical space based on the CPS, a process of simulating (making trials of) an ideal physical space after transformation in advance in the cyberspace is assumed.

For an effective simulation in the above process, it is necessary to precisely reproduce (project) the physical space before the change on the cyberspace. In addition, the projection onto the cyber space needs to be sufficiently reliable as a digital twin in the physical space.

As a method for estimating an object position in the physical space, self-position estimation/positioning for estimating a position by absolute positioning based on GNSS signals, relative positioning based on information of a hexaxial sensor, or the like, and position estimation of another object for estimating a position by capturing the other object by an external sensor such as a camera other than the above object are assumed.

### CITATION LIST

### Non Patent Literature

[NPL 1] Yoshida et al., High value-added positional information service by cooperation of GNSS and network, NTT technique journal, 2019.4
[NPL 2] Sakai, Security of GPS, Journal of the Reliability Society of Japan, pp. 158-164, Vol. 39 No. 4/2017

### SUMMARY OF INVENTION

### Technical Problem

When a physical space is projected onto a cyberspace, erroneous projection may be performed due to an accidentally/spontaneously occurring event, a disturbance event from the outside of the object, an intentional position disguise event of the object itself, and the like. Although a technique for avoiding an erroneous projection has been proposed by NPLs 1, 2, and the like, the existing techniques cannot cope with a disguise event of an object itself.

The present invention has been made in view of the above points, and an object thereof is to provide a technique capable of improving the reliability of projection from the physical space to the cyber space and avoiding erroneous projection.

### Solution to Problem

According to the disclosed technique, a multi-factor collating system in a cyber-physical system is provided in which a physical space and a cyber space are connected by a network wherein the multi-factor collating system includes a collating unit which determines whether to project the object onto the cyber space, based on first positional information that is positional information of the object obtained by positioning means of the object in the physical space, and second positional information that is positional information of the object obtained by means other than the positioning means; and a projection unit which projects the object to the cyber space, when the collating unit determines that the object is to be projected onto the cyber space.

### Advantageous Effects of Invention

According to the disclosed technique, it is possible to improve the reliability of projection from the physical space to the cyber space, and avoid erroneous projection.

### BRIEF DESCRIPTION OF DRAWINGS

FIG. 1 is a diagram for explaining an assumed environment.

FIG. 2 is a diagram for explaining an assumed environment.

FIG. 3 is a diagram for explaining a problem.

FIG. 4 is a diagram for explaining a problem.

FIG. 5 is a diagram for explaining an overview of an embodiment.

FIG. 6 is a system configuration diagram according to an embodiment.

FIG. 7 is a sequence diagram for explaining an operation of the system.

FIG. 8 is a flowchart for explaining Example 1.

FIG. 9 is a flow chart for explaining Example 2.

FIG. 10 is a sequence diagram for explaining Example 8.

FIG. 11 is a diagram for explaining an example of the hardware configuration of a device.

### DESCRIPTION OF EMBODIMENTS

Embodiments (present embodiment) of the present invention will be described below with reference to the drawings. The embodiments described below are merely examples, and embodiments to which the present invention is applied are not limited to the following embodiments.

In the following, a technique will be described for collating a plurality of information elements when projecting the physical space onto the cyber space, and executing projection in consideration of the collating result in a Cyber-Physical System in which the physical space and the cyber space (logical space) are connected by a network. Collation of a plurality of information elements is called “multi-factor collation”.

### (For Assumed Environment)

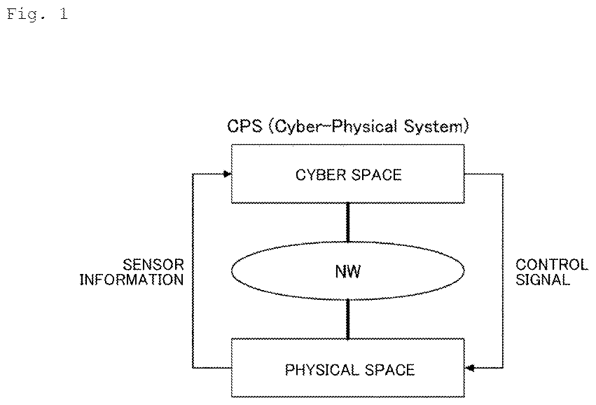

First, an environment to be assumed in the CPS will be described. FIG. 1 shows the CPS. As described above, in the CPS, an object and a phenomenon on the physical space are captured by a sensor, and the captured state is projected onto the cyber space connected by the NW, thereby executing control and simulation of the physical space. Specifically, “cyber space” is, for example, a database that stores information including identifiers in the cyber space of the object and positional information of the object. The term “projection” corresponds to storage of information in a database constituting the cyber space.

The objects in the physical space can be classified into the following three types of A, B and C.
A: An object which distributes information on its own position (or similar thereto) by the object itself
B: An object other than A connected to NW
C: An object which does not have a communication means and is not connected to the NW

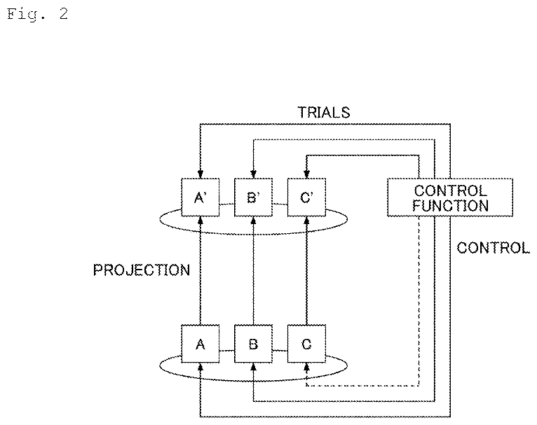

FIG. 2 shows a CSP which targets A, B and C of the physical space. For A, B, and C, objects projected onto the cyber space are shown as A′, B′, and C′. FIG. 2 shows that the control function performs the trial for transforming A, B, and C of the physical space on A′, B′, and C′.

Here, A can perform estimation/positioning of the position of itself by itself and distribute it. That is, the projection subject to the cyber space is A itself. On the other hand, for B and C, the projection subject to the cyber space is outside, and other objects other than the object themselves perform the position estimation.

As a factor in inhibiting precise projection, there are disturbance in position estimation/positioning in all of A to C. In addition, for A, intentional position disguise and instability of the communication are also factors. For B and C, reproduction duplication due to double capture/non-reproduction due to capture failure is also a factor.

In the present embodiment, a technique for solving the problem related to projection of an object A for actively distributing its own position will be described.

### (Problem)

This problem will be described in detail below. In the CPS, a GNSS positioning calculation result (position) delivered by the object itself and an identifier (referred to as NW management ID) of the object (for example, a terminal) on the NW used for delivery are projected on the cyber space as true values in the physical space and managed.

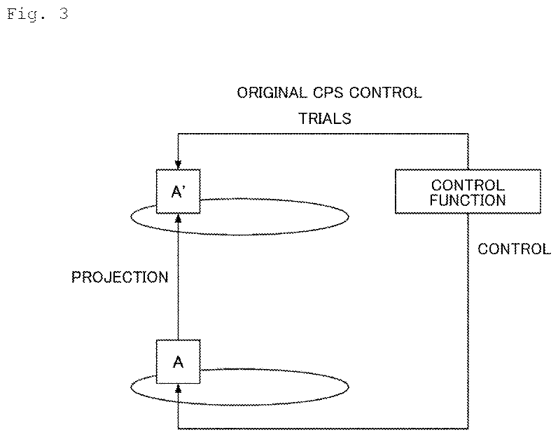

When positions delivered by the object coincides with actual positions in the physical space, intended correct CPS control is implemented as shown in FIG. 3.

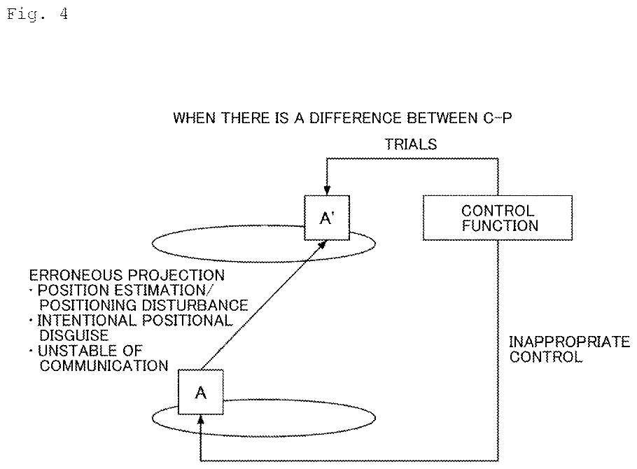

However, when a position delivered by the object is different from an actual position on the physical space, a difference occurs between the physical space and the cyber space as the projection, as shown in FIG. 4. In such a case, effective simulation cannot be performed, and hence, the physical space cannot be appropriately changed (controlled).

For example, although the above difference occurs due to the intentional disguise of the object itself (disguise event inside the object), the conventional technique cannot cope with such disguise of the position.

Factors causing erroneous projection include an accidentally/spontaneously occurring event and a disturbance event from the outside of the object, in addition to the disguise event inside the object. Hereinafter, for each of them, an existing technique/approach for avoiding the factor, problems upon introduction, and common problems that may remain after introduction will be described.

### <(1) Accidentally/Spontaneously Occurring Event>

As the accidentally/spontaneously occurring event, a multipath GNSS signal, an out-of-service area of the GNSS signal, and the like are applicable. As an existing technique for avoiding erroneous projection on the multipath of the GNSS signal, there is a satellite signal selection algorithm disclosed in NPL 1, but there is an introduction problem in cost, technique maturation and spread, and the like.

Also, as an existing technique for avoiding erroneous projection of the GNSS signals on an out-of-service area, dead reckoning and composite positioning utilizing IMS, images, and the like disclosed in NPL 1 are available. However, there are issues with terminal equipment/function dependence, cost, and the like.

<(2) Disturbance Event from Outside of Object>

Jamming/disguise of GNSS signals is known as a disturbance event from the outside of the object. As an existing technique for avoiding erroneous projection to this, there is an addition of an authentication signal to an array antenna/GNSS signal disclosed in NPL 2, but the array antenna has introduction issues of military use (no private sector circulation) and the need for total replacement of GNSS infrastructure (non-realistic).

There is the following common issue which commonly remains even after introduction “(1) an accidentally/spontaneously occurring event” and “(2) a disturbance event from the outside of an object”. That is, any existing technique is a solution approach to the disturbance of the position estimation/positioning of the object (A), and cannot cope with intentional disguise of the position of the object (A) itself or information disguise necessary for the position estimation/positioning.

### <(3) Disguise Event in Object>

As a disguise event in the object, there is a change in a positioning calculation result (positional information) used in the object. As existing techniques for avoiding erroneous projection with respect to such an event, there are monitoring and security enhancement of software/API operating inside an object, as disclosed in NPL 2. However, the existing technique has introduction problems such as software advancement, constant update, and resource consumption including power.

Also, even after the introduction of the above-mentioned existing technique, it is not possible to cope with hacking of the object itself including a forced stop of the monitoring/interrupting software.

Although the problem assumed in this embodiment is mainly the “disguise event inside the object”, the technique according to the present invention is also effective for “accidentally/spontaneously occurring event” and “disturbance event from outside the object”. That is, the technique according to the present invention functions as a method for solving the problems with respect to “accidentally/spontaneously occurring event” and “disturbance event from the outside of an object”, and contributes to improvement of the reliability of the reproduction and the fine reproduction of the physical space on the cyber space. In other words, the technique according to the present invention can improve the reliability of projection from the physical space to the cyber space, and can avoid erroneous projection.

### Overview of Embodiment

Next, an overview of the present embodiment will be explained. In the present embodiment, a CPS projection multi-factor collation method utilizing the NW side positioning will be described.

In this system, a projection request based on active position delivery of an object (A) in a physical space is subjected to multi-factor collation and projected onto a cyber space. Thus, the reliability of the cyber space as the projection of the physical space is improved by avoiding both of the following inhibition factors.
Disturbance in position estimation/positioning of the terminal (information) subject
Intentional disguise of the position or disguise of the information necessary for position estimation/positioning on the terminal side

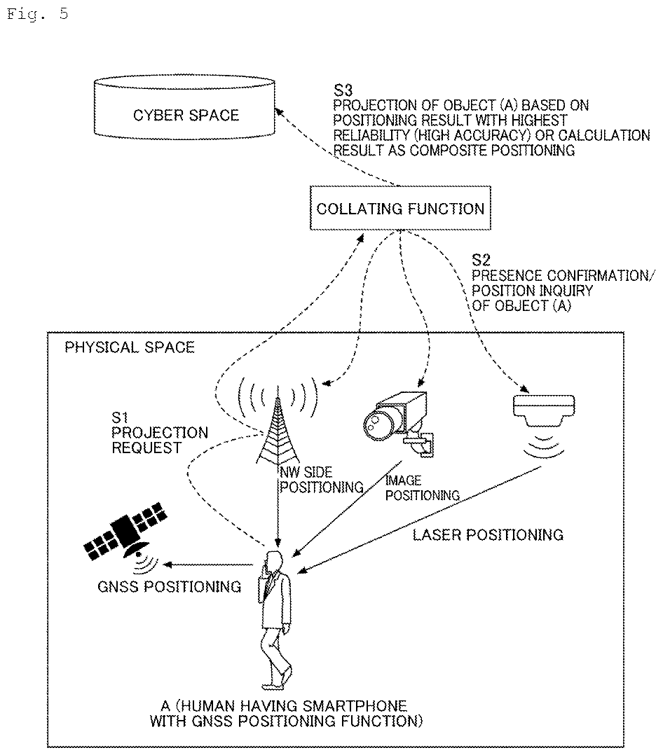

An overview will be described with reference to FIG. 5. FIG. 5 shows an example in which the object (A) is a person who possesses a smartphone with GNSS functions. As shown in FIG. 5, the position of a person (smartphone) is acquired by the GNSS positioning. Further, the person positioning is performed by the NW side positioning, image positioning, the laser positioning, etc.

In S1, a projection request including the positional information obtained from positioning is transmitted from the object (A) to the system side. In S2, a collating function performs presence confirmation/position inquiry of the object (A). In S3, the collating function generates a projection of the object (A) based on the positioning result having the highest reliability (high accuracy) or the calculation result as the composite positioning.

The above-mentioned collating function includes functions of a collating unit 130 and a projection unit 110, which will be described below. For example, the collating function determines whether to project the object (A) to the cyber space, based on first positional information which is positional information of the object (A) obtained by positioning means of the object (A), and second positional information which is positional information of the object (A) obtained by means other than the positioning means of the object (A). The means other than the positioning means of the object (A) may be any of the NW side positioning means, the image positioning means, and the laser positioning means, or may be other means. Further, a plurality of positioning means may be included in the means other than the positioning means of the object (A).

For example, the collating function determines reliability of the first positional information by comparing the first positional information with the second positional information. For example, the collating function compares the first positional information with the image positioning result, and compares the first positional information with the NW side positioning result. If a difference is less than or equal to a threshold value in any of these comparison results, the collating function can determine that the first positional information is reliable to a certain extent. If the difference between one positioning result (for example, NW side positioning result) considered to be high in reliability and the first positional information is less than or equal to a threshold value, the first positional information may be determined to be reliable to a certain extent.

When it is determined that the first positional information is reliable to a certain extent, the collating function may perform projection to the cyber space using “most probable positional information among the first positional information and one or multiple items of positional information included in the second positional information” or “positional information estimated based on at least one item of positional information among the first positional information and one or multiple items of positional information included in the second positional information”.

For “the most probable positional information among the first positional information and one or multiple items of positional information included in the second positional information”, for example, among the positioning means which obtain the second positional information, positioning means having the highest reliability may be determined in advance, and the positional information obtained by the positioning means may be set as “the most probable positional information among the first positional information and one or multiple items of positional information included in the second positional information”. Also, for example, a current predicted position of the object (A) is calculated by a method to be described later, and the positional information closest to the predicted position among “the first positional information and one or multiple items of positional information included in the second positional information” may be set as “the most probable positional information among the first positional information and one or multiple items of positional information included in the second positional information”.

For “positional information estimated based on at least one item of positional information among the first positional information and one or multiple items of positional information included in the second positional information”, for example, a center of gravity position of all or any positional information among the “the first positional information and one or multiple items of positional information included in the second positional information” may be used.

### (System Configuration)

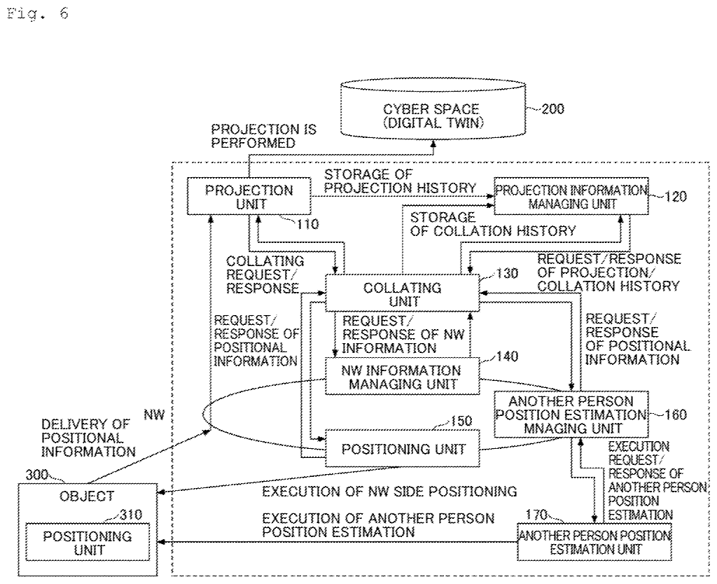

FIG. 6 shows a configuration example of a multi-factor collating system according to this embodiment. As shown in FIG. 6, the multi-factor collating system according to the present embodiment includes a projection unit 110, a projection information managing unit 120, a collating unit 130, an NW information managing unit 140, a positioning unit 150 for performing the NW side positioning, an another person position estimation managing unit 160, and an another person position estimation unit 170 for performing the image positioning, the laser positioning, or the like.

FIG. 6 shows an object 300 (object A) having a positioning unit 310 and a cyber space (digital twin) 200.

The operations of each unit will be described in the following sequence and examples. Part of the functions enclosed by the dotted line in FIG. 6 may be implemented by one device (computer) or may be distributed and implemented by multiple devices.

### (Sequence)

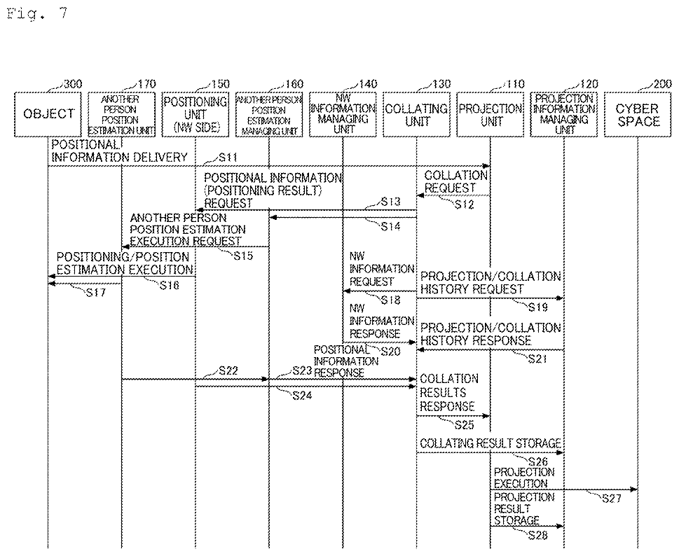

An example of the operations of the multi-factor collating system will be described with reference to FIG. 7. In S11, positional information (equivalent to a projection request) is delivered from the object 300 to the projection unit 110. In S12, the projection unit 110 transmits a collating request to the collating unit 130.

The collating unit 130 which receives the collating request transmits the positional information (positioning result) request to a positioning unit (NW side) 150 (S13), and transmits a positional information (positioning result) request to the another person position estimation managing unit 160 (S14).

The another person position estimation managing unit 160 which receives the positional information (positioning result) request requests the another person position estimation unit 170 to execute another person position estimation in S15.

Further, the positioning unit (NW side) 150 performs the positioning/position estimation of the object 300 in S16, and the another person position estimation unit 170 performs the positioning/position estimation of the object 300 in S17.

In S18, the collating unit 130 transmits the NW information request to the NW information managing unit 140, and receives the NW information response in S20.

The collating unit 130 transmits a projection/collation history request to the projection information managing unit 120 in S19, and receives the projection/collation history response in S21.

In S22 to S24, the collating unit 130 receives a response of the positional information obtained by each of the another person position estimation unit 170 and the positioning unit (NW side) 150. The collating unit 130 determines whether the object 300 is projected to the cyber space 200, using the positional information and history information obtained from the response.

The collating unit 130 makes a response with the collating result to the projection unit 110 in S25, and stores the collating result in the projection information managing unit 120 in S26.

When the collating result indicates a determination result that projection is performed, the projection unit 110 performs projection in S27, and stores the projection result in the projection information managing unit 120 in S28.

Examples 1 to 8 will be described below as more specific examples of processing. Examples 1 to 8 are examples in the following cases, respectively.
Example 1: A case where the comparison target of positioning based on GNSS signals is only NW side positioning
Example 2: A case where positioning based on the camera image and the LiDAR can be used as another person position estimation unit 170
Example 3: A case where collation is performed based on a difference between real-time positions (positioning results)
Example 4: A case where the collation is executed by referring to the history of the position transition
Example 5: A case where the collation is executed by referring to the projection history onto the cyber space
Example 6: A case where the collation is performed based on a difference from the result (future position) of the position prediction based on the history
Example 7: A case of referring to the collation history
Example 8: A case where the technique according to the present invention is applied to an A-GNSS positioning scheme defined in 3GPP

The object, projection target, position estimation/positioning method, and collating logic in the example are summarized as follows. The following is an example, and the projection target, the position estimation/positioning method, and the collating logic other than the following may be used.

### <Object>

An object is to secure reliability as a digital twin by precisely projecting an object in a physical space onto a cyber space.

### <Projection Target>

Examples of projection targets are as follows:
Communication terminal (smartphone, etc.)
A device with a communication terminal (such as a motor vehicle)
Owner of communication terminal

### <Position Estimation/Positioning Method>

Examples of position estimation/positioning methods are as follows:
GNSS positioning
Autonomous navigation (IMS, geomagnetism) positioning
Base station positioning
Camera image positioning
LIDAR positioning
IMES (Indoor Messaging System)
Wi-Fi (registered trademark) positioning
Sonic positioning
Atmospheric pressure positioning
Beacon positioning
Visible light positioning

### <Collating Logic>

Examples of collating logic are as follows:
A difference between real-time positions (positioning results) (single/multiple positioning methods)
A history of position transitions (single/multiple positioning methods).
A history of projection onto the cyber space
A difference from position prediction results based on history
Collation history

Examples 1 to 8 will be described below. Examples 1 to 8 can be implemented in any combination.

### Example 1

First, Example 1 will be described. Example 1 is an example in which a comparison target of positioning based on GNSS signals is only NW side positioning.

In the example 1, upon delivery of positional information (projection request) from the object 300, the collating unit 130 acquires the result of the NW side positioning, and compares it with positional information delivered from the object. For NW side positioning, for example, positioning based on radio wave propagation between base station and terminal specified by 3GPP (specifically, 3GPP TS 38.305, etc.) can be used.

When it is confirmed that the object 300 exists at the position on the physical space based on the comparison result, the collating unit 130 performs projection to cyber space, based on the positional information delivered from the object 300, the result of the NW side positioning, or the positioning result calculated by combining these positioning results in a complex manner.

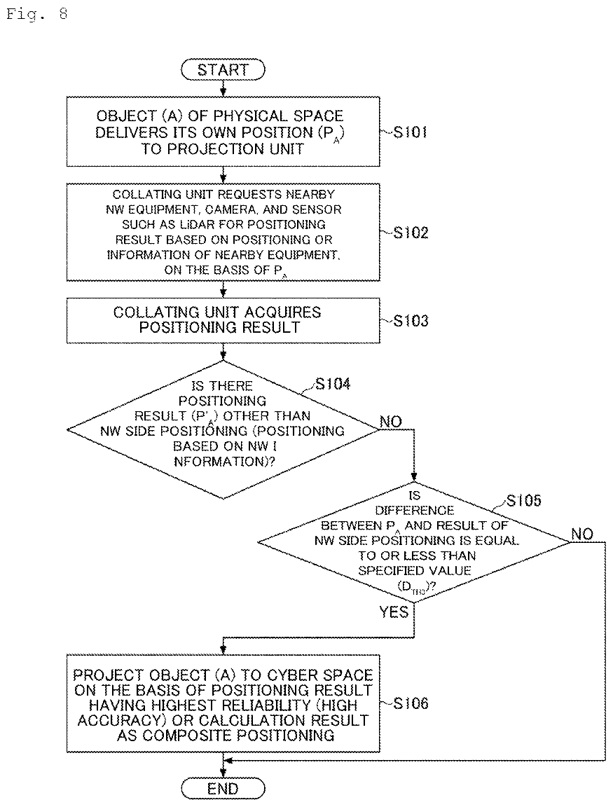

An operation of Example 1 will be described with reference to the flowchart of FIG. 8. In S101, an object 300 (object A) of the physical space distributes its own position (P_{A}) to the projection unit 110. The delivery of this position corresponds to a projection request.

In S102, the collating unit 130 requests the NW equipment near the P_{A} (positioning unit (NW side) 150), a camera, and a sensor such as a LIDAR (another person position estimation unit 170) for positioning result based on positioning or the information of the nearby equipment, based on P_{A}. In S103, the collating unit 130 acquires the positioning result on the NW side.

In S104, the collating unit 130 determines whether there is a positioning result (P′x) other than NW side positioning (positioning based on NW information). In the Example 1, since there is no positioning result (P′A) other than NW side positioning (positioning based on NW information), the process proceeds to S105.

In S105, the collating unit 130 determines whether a difference between the P_{A} and NW side positioning results is less than or equal to a prescribed value (predetermined threshold value) Dₜₕ₃. When the determination result of S105 is Yes (when Dₜₕ₃ or less), the process proceeds to S106, and when the determination result is No, the process ends.

In S106, the projection unit 110 projects the object 300 to the cyber space based on the positioning result having the highest reliability (high accuracy) or the calculation result as the composite positioning.

### Example 2

Next, Example 2 will be described. Example 2 is an example in which positioning based on the camera image and the LiDAR can be used as the function of the another person position estimation unit 170.

In the Example 2, upon delivery of the positional information delivery (projection request) from the object 300, the collating unit 130 acquires a positioning result based on the camera image and a positioning result based on the LiDAR in addition to the NW side positioning, and compares the positioning result with the positional information delivered from the object. The positioning based on the camera image and the positioning based on the LiDAR are examples, and other another person position estimating functions may be used alone or in combination of a plurality of functions.

When it is confirmed that the object 300 exists at the position on the physical space based on the comparison result, the collating unit 130 performs projection onto the cyber space, based on the positional information delivered from the object 300, the result of NW side positioning, the result of another person position estimation, or the positioning result calculated by combining these positioning results in a complex manner.

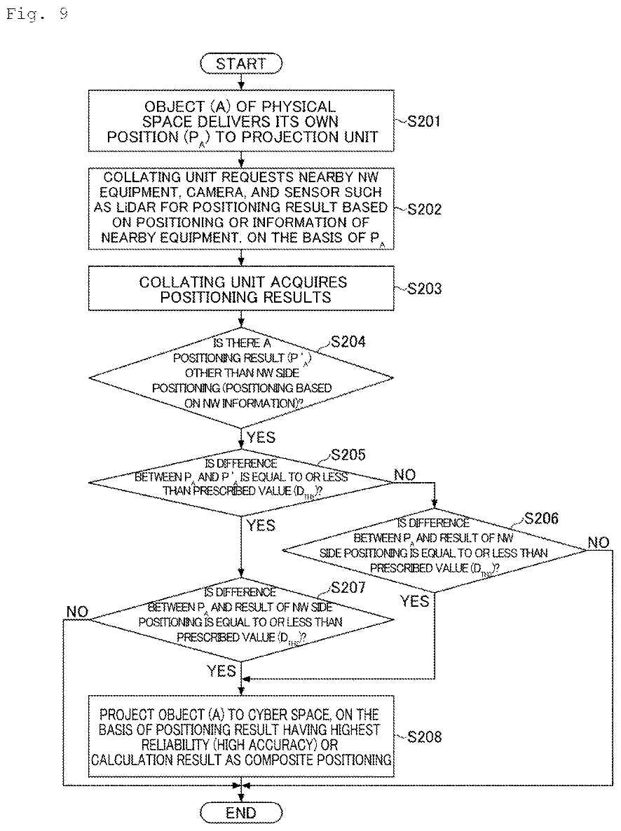

An operation of Example 2 will be described with reference to the flowchart of FIG. 9. In S201, an object 300 (object A) of the physical space delivers its own position (P_{A}) to the projection unit 110. The delivery of this position corresponds to a projection request.

In S202, the collating unit 130 requests the NW equipment, the camera, and a sensor such as a LIDAR near the P_{A} for a positioning result based on positioning or the information of the nearby equipment, based on P_{A}. In S203, the collating unit 130 acquires various positioning results.

In S204, the collating unit 130 determines whether there is a positioning result (P′_{A}) other than NW side positioning (positioning based on NW information). In Example 2, since a positioning result (P′_{A}) other than the NW side positioning exists, the process proceeds to S205.

In S205, the collating unit 130 determines whether a difference between P_{A} and P′_{A}, is less than or equal to a prescribed value Dem, and if the positioning result is No (when the positioning result is not less than or equal to Dₜₕ₁), the process proceeds to S206, and if the positioning result is Yes, the process proceeds to S207.

In S206 in the case of No in S205, the collating unit 130 determines whether a difference between P_{A} and the result of NW side positioning is less than or equal to a prescribed value Dₜₕ₃. When the determination result of S206 is Yes, the process proceeds to S208, and when the determination result is No, the process ends.

In S207 in the case of Yes in S205, the collating unit 130 determines whether a difference between P_{A} and the result of NW side positioning is less than or equal to a prescribed value Dₜₕ₂. When the determination result of S207 is Yes, the process proceeds to S208, and when the determination result is No, the process ends.

In S208, the projection unit 110 projects the object 300 (object A) to the cyber space, based on the positioning result having the highest reliability (high accuracy) or the calculation result as the composite positioning.

The threshold value used in S206 and S207 has a relation of Dₜₕ₃>Dₜₕ₂. That is, S207 performs the estimation more severely than in S206. The reason is as follows.

The NW side positioning may be the coverage level (rough) of the base station, and the threshold value is set on the assumption that a locally disposed/functioning another person position estimation function can more accurately estimate the position. For this reason, Dₜₕ₃>Dₜₕ₂ is established.

However, in 5 G, since the radio wave used for communication becomes a high frequency, high accuracy of positioning is assumed, and it is necessary to set the threshold value according to the position accuracy obtained by NW side positioning. Although the accuracy of another person position estimation is also improved year by year, the magnitude relation between the Dₜₕ₃ and the Dₜₕ₂ is also reversed depending on the case.

### Example 3

Next, Example 3 will be described. Example 3 is an example in which collation is performed based on a difference between real-time positions (positioning results). Example 3 can be applied to any of Examples 1 and 2.

In the Example 3, the collating unit 130 compares the difference between the positional information delivered from the object 300 and one or a plurality of object positions obtained by different position estimation/positioning methods at the time of the multi-factor collation. When the value is less than or equal to the specified value, it is regarded that the object is confirmed to be present at the position on the physical space, and projection is permitted. When the value exceeds the specified value, the projection request from the object is not accepted.

However, the projection based on an another person position estimation which occurs as an independent event from the projection request from the object is not limited to this.

### Example 4

Next, Example 4 will be described. Example 4 is an example in which the collation is executed by referring to the history of the position transition. Example 4 can be applied by any combination of Examples 1 to 3.

In the Example 4, the collating unit 130 also refers to the past object position and the base station connection history, in addition to the real-time object position obtained as a snapshot in the case of the multi-factor collation.

The past object position and base station connection history are stored, for example, in the NW information managing unit 140, and these items of information can be acquired by S18 and S20 shown in a sequence of FIG. 7.

The collating unit 130 takes into account whether the object position or the connected base station is extremely discrete, or whether continuity exceeding a prescribed level can be secured in consideration of a power source (communication function) off time, into a collating element.

Specifically, for the continuity of the object position, the moving speed (v) of the object is calculated based on the history of the position transition, and it is determined whether the positional information in the range (d=v (the time from the positional information reception time in the latest history to the reception of the newly delivered positional information)) which transitions at the moving speed is delivered.

The history of the position transition may be a history of results based on a single position estimation/positioning method, or may be a history of results based on a plurality of different position estimation/positioning methods.

The continuity of the base station connection is determined by whether there is no discrepancy in the geographical positional relation between the object position and the deployed base station or whether handover between the base stations which are not geographically adjacent is generated.

In any case, since there is a possibility that the data may become discrete before and after the power source (communication function) is turned ON/OFF regardless of the presence or absence of the intentional position disguise, the history of the position transition is handled as one of a plurality of elements to be utilized for the collation, instead of collating by history only.

### Example 5

Next, Example 5 will be described. The Example 5 is an example in which the collation is executed by referring to the projection history onto the cyber space. The Example 5 can be applied by any combination of Examples 1 to 4.

In the Example 5, the collating unit 130 also refers to the projection history of the object 300 (the NW management ID possessed by it) onto cyber space, in addition to the real-time object position obtained as a snapshot, when performing the multi-factor collating.

The projection history is stored, for example, in the projection information managing unit 120, and the information can be acquired by S19 and S21 shown in the sequence of FIG. 7.

The collating unit 130 adds considerations whether a projection request from a current object is far away from a projection history so far, and whether continuity more than a prescribed level can be secured in consideration of a power source (communication function) OFF time, into a collating element.

The continuity of projection is determined based on the position of the projected object or the property of the object (physical/external feature or the like). As for the determination based on the position of the object, the same determination method as in the Example 4 can be applied.

In any case, before and after the power source (communication function) is turned ON/OFF, or before and after the transfer or loss of a communication terminal, continuity may be lost regardless of whether there is intentional position disguise. Thus, the projection history is treated as one of the multiple elements used for collating, rather than collating using only the history.

### Example 6

Next, Example 6 will be described. The Example 6 is an example in which the collation is performed based on a difference from a result of position prediction (future position) based on a history. The Example 6 can be applied by any combination of Examples 1 to 5.

In the Example 6, the collating unit 130 refers to a difference from future positions of objects predicted from the history of the position transition or projection, in addition to real-time object positions obtained as snapshots, when performing the multi-factor collation. For example, a difference between the current position delivered from the object and the current position of the object obtained by the position prediction is referred to.

The information for calculating the position transition can be acquired by S18 and S20 in the sequence of FIG. 7, and the projection history can be acquired by S19 and S21 in the sequence of FIG. 7.

The collating unit 130 compares whether the object position is far away from the predicted future position (whether the difference exceeds a threshold value) and whether the difference of the position is less than or equal to a prescribed value in consideration of the power source (communication function) OFF time.

The position prediction may be performed based on the moving speed of the object as described in Example 4, or may be performed based on movement plan of the object, the property of the object, the external object/phenomenon related to the object, and the behavior of the object derived from the surrounding environment/situation.

In any case, since there is a possibility that the difference becomes large before and after the power source (communication function) is turned ON/OFF or in an object in which a steep behavior is seen regardless of the presence or absence of an intentional position disguise, the difference from the position prediction result is treated as one of the multiple elements utilized for collation, rather than only the difference from the position prediction result.

### Example 7

Next, an Example 7 will be described. The Example 7 is an example in which the collation history is referred to. The Example 7 can be applied in combination with any of Examples 1 to 6.

In the Example 7, the collating unit 130 refers to how much the projection request of a certain object has been approved or rejected in the past, in addition to the real-time object position obtained as a snapshot, in the case of the multi-factor collation. For example, when the projection has been rejected for a predetermined number of times or more in the past, the projection is rejected even if there is no problem in collation based on the comparison of the positional information.

The collation history is stored in, for example, the projection information managing unit 120, and the information can be acquired by S19 and S21 shown in a sequence of FIG. 7.

Also, the collating unit 130 makes the conditions used for setting and collating various threshold values variable for each projection request, based on the reliability of an object (information delivered from the object) such as setting various threshold values and setting conditions used for strict collation setting for the object in which intentional disguise is frequently seen (low reliability).

However, since the reliability also changes depending on the environment of the object or the change of the owner, the collation is not performed only by the collation history, but the collation history is handled as one of a plurality of elements to be utilized for collation.

### Example 8

Next, an Example 8 will be described. The Example 8 is an example when the technique according to the present invention is applied to an A-GNSS positioning scheme defined in 3GPP. The Example 8 can be applied in combination with any of Examples 1 to 7. The A-GNSS positioning method is disclosed in, for example, “NTT DOCOMO Technical Journal Vol. 2 No. 4 Advancement of Positioning Method for Smartphones-A-GNSS (GPS+GLONASS) Positioning Support and UE-A Positioning Support”.

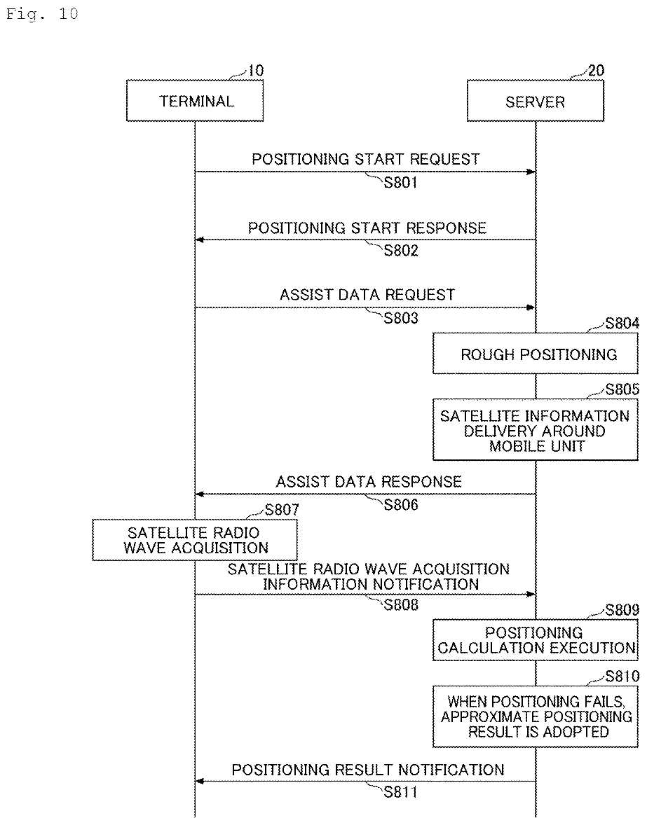

First, a procedure example of UE-A positioning of the A-GNSS positioning system described in the above-mentioned literature will be described. An example will be described with reference to FIG. 10. In FIG. 10, a server 20 is an SUPL Location Platform (SLP), and is a server that performs assist data delivery for positioning or the like.

In S801, the terminal 10 transmits a positioning start request to the server 20, and in S802, the server 20 returns the positioning start response. When the terminal 10 transmits the assist data request to the server in S803, the server 20 performs the rough positioning (S804) and satellite information delivery (S805) around the mobile unit (terminal). Assist data including the satellite information is returned to the terminal 10 in S806.

In S807, the terminal 10 acquires the satellite radio waves, and in S808, the terminal 10 makes a notification of the satellite radio wave acquisition information. In S809, the server 20 executes the positioning calculation. When the positioning fails, an approximate positioning result is adopted (S810). In S811, the server 20 notifies the positioning result to the terminal 10.

In the UE-A positioning (refer to FIG. 3 of literature ※) of the A-GNSS positioning system as described above, the NW side positioning based on the technique according to the present invention and the position estimation by another person position estimation unit 170 are performed when the positioning calculation is performed by the SLP (server 20), and the result is transmitted to the outside including the terminal 10 (cyber space according to the technique according to the present invention).

By regarding a positioning start request from the terminal 10 as a projection request to a cyber space, and regarding a reception result of a satellite radio wave acquisition information notification transmitted from the terminal 10 as information having a possibility of being disguised, the technique according to the present invention can be applied to a mobile communication network conforming to the regulation of 3GPP in accordance with a data flow similar to the flow shown in FIG. 7 or the like.

### (Hardware Configuration Example)

A multi-factor collating system can be implemented, for example, by causing a computer to execute a program. The computer may be a physical computer or a virtual machine on a cloud.

That is, the multi-factor collating system can be implemented, by executing a program corresponding to the processing performed by the multi-factor collating system, using hardware resources such as a CPU and memory built into the computer. The program can be recorded on a computer-readable recording medium (a portable memory or the like) to be stored and delivered. Furthermore, the program can also be provided through a network such as the Internet or an electronic mail.

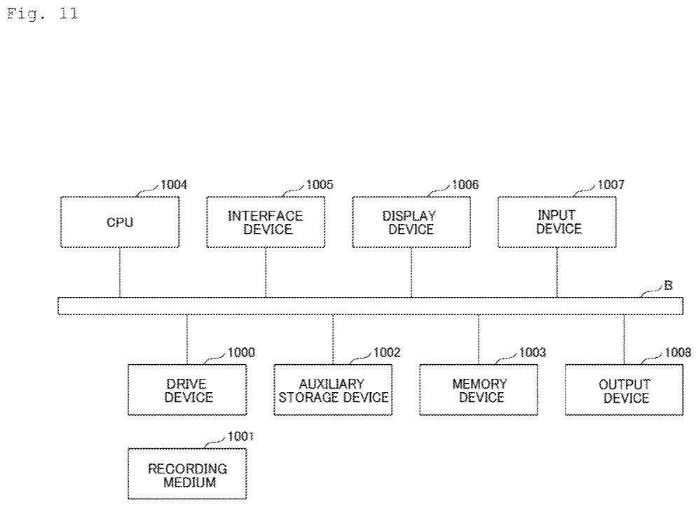

FIG. 11 is a diagram showing a hardware configuration example of the computer. The computer shown in FIG. 11 has a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 through the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 realizes functions related to the light touch maintenance device 100 according to a program stored in the memory device 1003. The interface device 1005 is used as an interface for connecting to a network or the like. The display device 1006 displays a Graphical User Interface (GUI) and the like according to the program. The input device 1007 is constituted by a keyboard and a mouse, buttons, a touch panel, or the like and is used for inputting various operation instructions. The output device 1008 outputs a calculation result.

### (Points and Effects of Embodiment)

As described above, in the present embodiment, the multi-factor collation is adopted for precise (reliable) projection.

More specifically, NW information is utilized for multi-factor collation. That is, since the NW information is indispensable as a social infrastructure for realizing the CPS and is useful as a wide range of reliable information sources, the NW information is utilized in the present embodiment. Further, the NW information is also utilized from the viewpoint of assuming application to a region in which security of mission critical property is required, even if a certain cost is required.

Further, in the present embodiment, it is possible to refer to the past positioning and base station connection history, in addition to the real-time positioning result utilizing the NW information.

In other words, it is possible to add the result of the NW side positioning, whether the connected base stations are not extremely discrete, or whether a certain degree of continuous stay can be expected in consideration of the power source (communication function) OFF time, to the collating element.

Further, in the present embodiment, it is possible to refer to the projection history of the object having the communication means onto the cyber space based on the “NW management ID of the object” assumed to be utilized as an identifier in the physical space.

Thus, presence or absence of continuity with the past projection after considering the power source (communication function) OFF time, and reliability of objects (information distributed from) estimated from multi-factor collating history can also be added to the collating elements.

As described above, according to the present embodiment, by coping with problems that may occur on the object side in the physical space that is the projection target into cyber space, based on information that can be obtained on the NW side and that is difficult to disguise on the object side, it is possible to improve the reliability of cyber space.

### (Appendix)

This specification discloses at least a multi-factor collating system, a multi-factor collating method, and a program of at least the following items.

### (Item 1)

A multi-factor collating system in a cyber-physical system in which a physical space and a cyber space are connected by a network, in which the multi-factor collating system includes a collating unit which determines whether to project an object onto the cyber space, based on first positional information that is positional information of the object obtained by positioning means of the object in the physical space, and second positional information that is positional information of the object obtained by means other than the positioning means; and
a projection unit which projects the object to the cyber space, in response to the collating unit determining that the object is to be projected to the cyber space.

### (Item 2)

In the multi-factor collating system according to Item 1, in which the collating unit determines reliability of the first positional information by comparing the first positional information with the second positional information, and determines whether to project the object to the cyber space based on the reliability.

### (Item 3)

In the multi-factor collating system of Item 1 or 2, in which the second positional information includes one or multiple items of positional information obtained by one or multiple means, and the projection unit performs projection to the cyber space, using most probable positional information among the first positional information and the one or multiple items of positional information or positional information estimated based on at least one positional information among the first positional information or the one or multiple items of positional information.

### (Item 4)

In the multi-factor collating system of any one of Items 1 to 3, in which the collating unit determines whether to project the object into the cyber space, based on continuity of position transition of the object, continuity of base station connection of the object, or continuity of projection of the object, in addition to a comparison result between the first positional information and the second positional information.

### (Item 5)

In the multi-factor collating system of any one of Items 1 to 4, in which the collating unit determines whether to project the object onto the cyber space, based on a difference between real-time positional information of the object and positional information obtained by position prediction of the object, in addition to the comparison result between the first positional information and the second positional information.

### (Item 6)

In the multi-factor collating system of any one of Items 1 to 5, in which the collating unit determines whether to project the object to the cyber space, based on a collation history indicating whether to permit projection with respect to the object, in addition to the comparison result between the first positional information and the second positional information.

### (Item 7)

A multi-factor collating method executed by a multi-factor collating system in a cyber-physical system in which a physical space and a cyber space are connected by a network, the multi-factor collating method including:
a collating step of determining whether to project an object onto the cyber space, based on first positional information that is positional information of the object obtained by positioning means of the object in the physical space, and second positional information that is positional information of the object obtained by means other than the positioning means; and
a projecting step of projecting the object to the cyber space, when the object is determined to be projected to the cyber space by the collating step.

### (Item 8)

A program for causing a computer to function as each unit of the multi-factor collating system according to any one of Items 1 to 6.

Although the embodiment has been described above, the present invention is not limited to the specific embodiment, and various modifications and changes can be made within the scope of the gist of the present invention described in the claims.

### REFERENCE SIGNS LIST

10 Terminal
20 Server
110 Projection unit
120 Projection information managing unit
130 Collating unit
140 NW Information managing unit
150 Positioning unit for performing NW side positioning
160 Another person position estimation managing unit
170 Another person position estimation unit
200 Cyber space (digital twin)
300 Object
310 Positioning unit
1000 Drive device
1001 Recording medium
1002 Auxiliary storage device
1003 Memory device
1004 CPU
1005 Interface device
1006 Display device
1007 Input device

1. A multi-factor collating system in a cyber-physical system in which a physical space and a cyber space are connected by a network, the multi-factor collating system comprising:
a computer including a memory and a processor configured to:
determine whether to project an object onto the cyber space, based on first positional information that is positional information of the object obtained by positioning means of the object in the physical space, and second positional information that is positional information of the object obtained by means other than the positioning means; and
project the object to the cyber space, in response to a determination that the object is to be projected to the cyber space.

2. The multi-factor collating system according to claim 1, wherein the unit processor determines a reliability of the first positional information by comparing the first positional information with the second positional information, and determines whether to project the object to the cyber space based on the reliability.

3. The multi-factor collating system according to claim 1, wherein the second positional information includes one or multiple items of positional information obtained by one or multiple means, and the processor performs projection to the cyber space, using most probable positional information among the first positional information and the one or multiple items of positional information or positional information estimated based on at least one positional information among the first positional information or the one or multiple items of positional information.

4. The multi-factor collating system according to claim 1, wherein the processor determines whether to project the object to the cyber space, based on continuity of position transition of the object, continuity of base station connection of the object, or continuity of projection of the object, in addition to a comparison result between the first positional information and the second positional information.

5. The multi-factor collating system according to claim 1, wherein the collating processor determines whether to project the object to the cyber space, based on a difference between real-time positional information of the object and positional information obtained by position prediction of the object, in addition to a comparison result between the first positional information and the second positional information.

6. The multi-factor collating system according to claim 1, wherein the unit processor determines whether to project the object to the cyber space, based on a collation history indicating whether to permit projection with respect to the object, in addition to the comparison result between the first positional information and the second positional information.

7. A multi-factor collating method executed by a computer in a multi-factor collating system in a cyber-physical system in which a physical space and a cyber space are connected by a network, the multi-factor collating method comprising:
determining whether to project an object onto the cyber space, based on first positional information that is positional information of the object obtained by positioning means of the object in the physical space, and second positional information that is positional information of the object obtained by means other than the positioning means; and
projecting the object to the cyber space, when the object is determined to be projected to the cyber space by the determining.

8. (canceled)

9. A non-transitory computer-readable recording medium having computer-readable instructions stored thereon, which, when executed, cause a computer to execute a method in a multi-factor collating system in a cyber-physical system in which a physical space and a cyber space are connected by a network, the method comprising:
determining whether to project an object onto the cyber space, based on first positional information that is positional information of the object obtained by positioning means of the object in the physical space, and second positional information that is positional information of the object obtained by means other than the positioning means; and
projecting the object to the cyber space, when the object is determined to be projected to the cyber space by the determining.
